(19) United States
(12) Patent Application Publication
(10) Pub. No.: US 2013/0015138 A1
(43) Pub. Date: Jan. 17, 2013

(54) COMPRESSIBLE LIQUID FLASH CHROMATOGRAPHY

(71) Applicants: Rolf Schlake, Nazareth, PA (US); Joseph Stefkovich, Cedar Grove, NJ (US); Ernie Schlegel, Allentown, PA (US); Martin Fetner, Allentown, PA (US); Alfred Kaziunas, Bangor, PA (US)

(72) Inventors: Rolf Schlake, Nazareth, PA (US); Joseph Stefkovich, Cedar Grove, NJ (US); Ernie Schlegel, Allentown, PA (US); Martin Fetner, Allentown, PA (US); Alfred Kaziunas, Bangor, PA (US)

(73) Assignee: APPLIED SEPARATIONS, INC., Allentown, PA (US)

(21) Appl. No.: 13/532,051

(22) Filed: Jun. 25, 2012

Related U.S. Application Data
(60) Provisional application No. 61/500,817, filed on Jun. 24, 2011.

(51) Int. Cl. B01D 15/42

(52) U.S. Cl. 210/656; 210/177

(57) ABSTRACT

A liquid flash chromatography process and system are disclosed for separating a sample. The process uses a compressible fluid such as liquid carbon dioxide (CO2) in one embodiment. The liquid CO2 forms the mobile phase into which a suitable solvent is be added for conducting the sample separation. In one embodiment, the process includes depressurizing the CO2 by lowering its temperature via cooling to maintain the CO2 in liquid phase through the chromatographic separation column. The CO2 pressure is maintained below 50 bar in some embodiments thereby obviating the need for high pressure pumps and heavily structured process components such as the column and other equipment to contain high pressure. In some embodiments, the liquid phase is cooled from the gas supply vessel through the column to control the CO2 temperature and hence pressure.

### CROSS-REFERENCE TO RELATED APPLICATIONS

The present application claims priority to commonly owned U.S. Provisional Application No. 61/500,817 filed Jun. 24, 2011, the entire contents of which is incorporated herein by reference in its entirety.

### BACKGROUND OF THE DISCLOSURE

The present disclosure generally relates to chromatography, and more particularly to a chromatographic separation system and process for separating an analyte from sample material using compressible liquid flash chromatography.

Chromatography has been widely used for the separation of mixtures containing an analyte substance or chemical constituent (hereafter “compound(s)” for brevity) of interest. Most flash chromatography separations use both polar and non-polar organic solvents such as methanol, ethanol, and hexane. Organic solvents used in flash chromatography have problems due to the density of the solvents making it hard to have good separations in chromatography columns containing silica 8 to 40 microns. Density of the solvents cause a pressure drop across the column causing voids in the columns giving poor separations. It is also expensive for disposal of used solvents.

One alternative chromatography method is to use SFC (Supercritical Fluid Chromatography) or high pressure flash chromatography that eliminates much of the solvent by using compressible carbon dioxide (“CO2”) to carry the solvent. But this is very expensive from a cost of ownership standpoint because of the high pressure CO2 pumps needed to pump the supercritical fluid, heaters, and large high pressure vessels necessary to contain the pressures involved. Other separation devices have been developed that use Supercritical CO2 at high pressures in the range from 50-350 bar resulting in similar drawbacks.

Another alternative is flash chromatography operated at low pressure (less than 10 bars, generally in about the 3-5 bar range), which is typically referred to as Low Pressure Liquid Chromatography (LPLC). These separation systems, however, generally suffer from excessive amounts of incompressible solvents being employed to effect the separation, which incurs an excessive cost to both acquire and properly dispose of the incompressible solvents. Any collection of sample and mobile phase into fractions requires subsequent separation of the sample compound or analyte of interest from the mobile phase which is typically a relatively slow recovery process compared to the use of compressible solvent chromatography systems.

An improved chromatography process is desired.

### SUMMARY OF THE DISCLOSURE

A flash chromatography system and process using compressible liquid CO2 as the mobile phase carrier according to embodiments of the present disclosure provide a cost effective technique to separate compounds of interest from samples. Embodiments of the present liquid CO2 flash chromatography system and process preferably operate at less than 50 bar, thereby eliminating the need for expensive high pressure liquid CO2 pumps and heavily structured components or pressure vessels necessary for the high pressure SFC chromatography processes described above. In some preferred embodiments, the present liquid CO2 flash chromatography process operates in a range between 10 and 50 bar. In addition, the liquid CO2 flash chromatography process according to the present disclosure offers faster sample recovery process speeds than chromatography systems using incompressible solvents for the mobile phase, as further explained herein.

Embodiments liquid CO2 flash chromatography systems according to the present disclosure may include coolant cooling of the liquid CO2 upstream of the chromatographic separation column or pressure vessel containing the stationary phase to reduce the temperature of and depressurize the CO2 for maintaining the CO2 in liquid phase preceding and through the separation column. In one embodiment, the column or pressure vessel itself is coolant cooled such as with a recirculating cooling bath to ensure the CO2 remains liquefied from inlet to outlet of the column or pressure vessel. A solvent supply system including a solvent pump is provided to mix a co-solvent with the liquid CO2 thereby defining the mobile phase carried through the column or pressure vessel to conduct the chromatographic separation of an analyte sample.

In one exemplary embodiment according to the present disclosure, a method for separating a sample using liquid flash chromatography includes: providing a pressure vessel containing a stationary phase adsorption material; providing a compressible fluid defining part of a liquid mobile phase for delivery to the pressure vessel; maintaining the compressible fluid in a liquid state before delivery to the pressure vessel; mixing a co-solvent with the compressible fluid thereby defining a liquid mobile phase; eluting the liquid mobile phase and the sample through the pressure vessel to extract a separated sample, wherein the pressure vessel is maintained between 10 and 50 bar during the elution; heating the mobile phase containing the separated sample to separate the mobile phase from the separated sample; and collecting the separated sample. In one embodiment, the method further includes cooling the pressure vessel to maintain the pressure between 10 and 50 bar. The method further includes in an embodiment depressurizing the compressible fluid to maintain the compressible fluid in a liquid state before delivery to the pressure vessel. In other embodiments, the compressible fluid is cooled to below 14 degrees C. to depressurize the fluid. In a preferred embodiment, the compressible fluid is CO2 .

In one exemplary embodiment according to the present disclosure, a compressible liquid flash chromatography system includes a pressure vessel containing a stationary phase adsorption material, a gas supply vessel holding a compressible liquid, and a heat exchanger for controlling the temperature of the compressed liquid. The heat exchanger receives the compressed liquid from the gas supply vessel and is operable to cool the compressed liquid to reduce a pressure of the compressed liquid and maintain the liquid in a liquid state. The system further includes a solvent supply system including a solvent pump for pumping an incompressible co-solvent, a mixer receiving the compressed liquid from the heat exchanger and co-solvent from the solvent pump; the mixer combining the compressed liquid and co-solvent to form a liquid mobile phase and delivering the liquid mobile phase to the pressure vessel. A cooling system is provided that is operable to cool the pressure vessel and gas supply vessel such that the temperature of the compressed liquid and liquid mobile phase is maintained between 10 and 50 bar.

### BRIEF DESCRIPTION OF THE DRAWINGS

The features of the exemplary embodiments will be described with reference to the following drawings where like elements are labeled similarly, and in which:

FIG. 1 is a system diagram of an embodiment of a compressible liquid flash chromatography system according to the present disclosure;

FIG. 2 is a vapor pressure graph for carbon dioxide;

FIG. 3 is a detector chromatogram showing examples of a baseline and analyte peak signal detected by a chromatographic detector of the system of FIG. 1;

FIGS. 4-5 are cross-sectional views of exemplary pressure vessel column useable in the chromatography of FIG. 1, which may be directly packed with adsorbent material; and

FIGS. 6-7 are cross-sectional views of exemplary pressure vessel column useable in the chromatography of FIG. 1, which are configured to receive disposable flash cartridges packed with adsorbent material.

All drawings are schematic and not necessarily to scale.

### DESCRIPTION OF EXEMPLARY EMBODIMENTS

The features and benefits of the invention are illustrated and described herein by reference to exemplary embodiments. This description of exemplary embodiments is intended to be read in connection with the accompanying drawings, which are to be considered part of the entire written description. In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” and “interconnected,” refer to a relationship wherein structures are secured or attached to one another either directly or indirectly through intervening structures, as well as both movable or rigid attachments or relationships, unless expressly described otherwise. Accordingly, the disclosure expressly should not be limited to such exemplary embodiments illustrating some possible non-limiting combination of features that may exist alone or in other combinations of features.

“Software”, as used herein, includes but is not limited to, one or more computer instructions and/or processor instructions that can be read, interpreted, compiled, and/or executed by a computer and/or processor. Software causes a computer, processor, or other electronic device to perform functions, actions and/or behave in a desired manner. Software may be embodied in various forms including routines, algorithms, modules, methods, and/or programs. In different examples software may be embodied in separate applications and/or code from dynamically linked libraries. In different examples, software may be implemented in executable and/or loadable forms including, but not limited to, a stand-alone program, an object, a function (local and/or remote), a servelet, an applet, instructions stored in a memory, part of an operating system, and so on. In different examples, computer-readable and/or executable instructions may be located in one logic and/or distributed between multiple communicating, co-operating, and/or parallel processing logics and thus may be loaded and/or executed in serial, parallel, massively parallel and other manners. Software is fixed in a tangible medium.

The inventors have discovered that a using a compressible fluid such as liquid CO2 at pressures below 50 bar as the mobile phase carrier through the chromatographic separation column advantageously does not require expensive high pressure CO2 pumps, heaters, and high pressure vessels as in high pressure SFC chromatography separation processes, while providing good separation performance. In a preferred embodiment, a CO2 pump is eliminated entirely requiring only a solvent pump to be used in the system. In addition solvent usage may advantageously be reduce by a factor of about 10 from about 10 liters of solvent typically used fin lash chromatography to about 1 liter in a liquid CO2 flash chromatography according to the present disclosure. This drastically reduces the amount of toxic solvent waste generated which must be disposed.

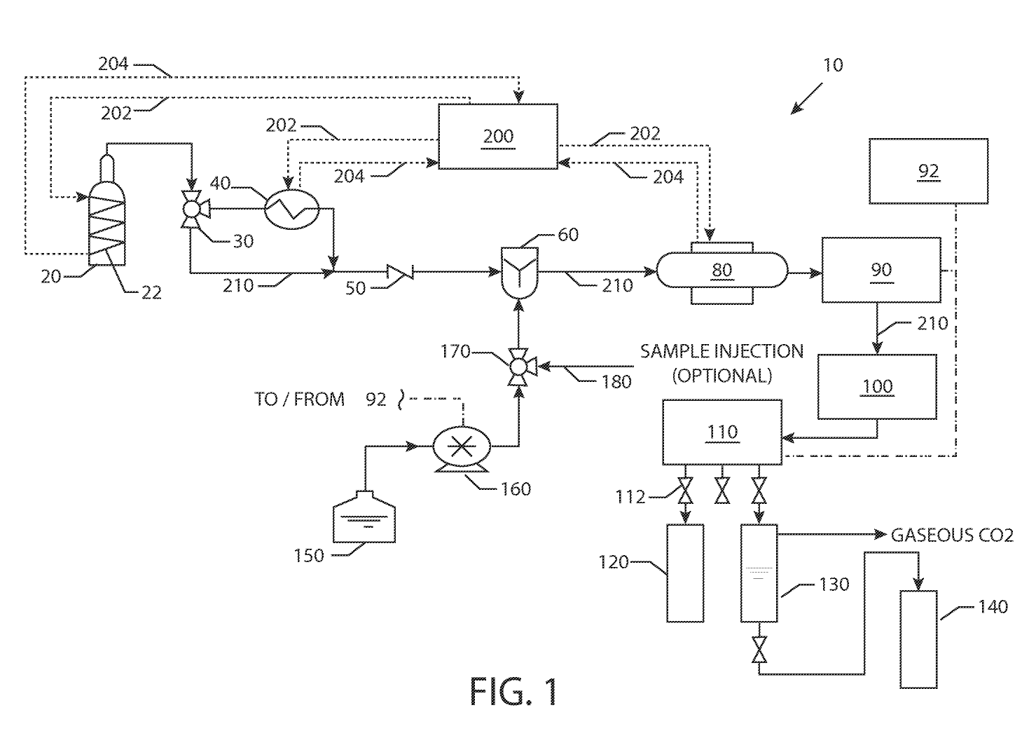

FIG. 1 depicts one embodiment of a liquid CO2 chromatography system 10 and process flow diagram according to the present disclosure. To achieve the foregoing advantages, the present chromatography system in one embodiment uses cooled liquid CO2 as the compressible mobile phase carrier, and depressurizes the CO2 below 50 bar by dropping the temperature sufficiently low enough to maintain the CO2 in a liquid state as the mobile phase carrier.

Referring now to FIG. 1, a source of liquid CO2 is provided to system 10 in an industrial gas supply vessel 20 such as a tank or cylinder typically at approximately 840 PSI (58 bar). Gas supply vessel 20 is preferably cooled below 14 degrees C. as needed to reduce the internal cylinder pressure below 50 bar, and ensure the CO2 in liquid phase for the start for process. In some embodiments, the CO2 is maintained between 10 and 50 bar to provide the ability to regulate and maintain a predetermined flow rate of liquid CO2 from gas supply vessel 20 through the chromatography system 10.

In one embodiment, gas supply vessel 20 is cooled by a cooling system such as a recirculating cooling bath (RCB) 200 using any suitable coolant fluid. In one embodiment, the coolant used without limitation is ethylene/glycol. Vessel 20 is cooled via cooling coils 22 or a cooling jacket connected to a cooling supply line 202 and a return line 204 fluidly connected to RCB 200. Tubing and/or piping may be used for lines 202, 204. RCB 200 may be any commercially available unit, such as without limitation the Spe-ed™ RCB Unit available from Applied Separations of Allentown, Pa.

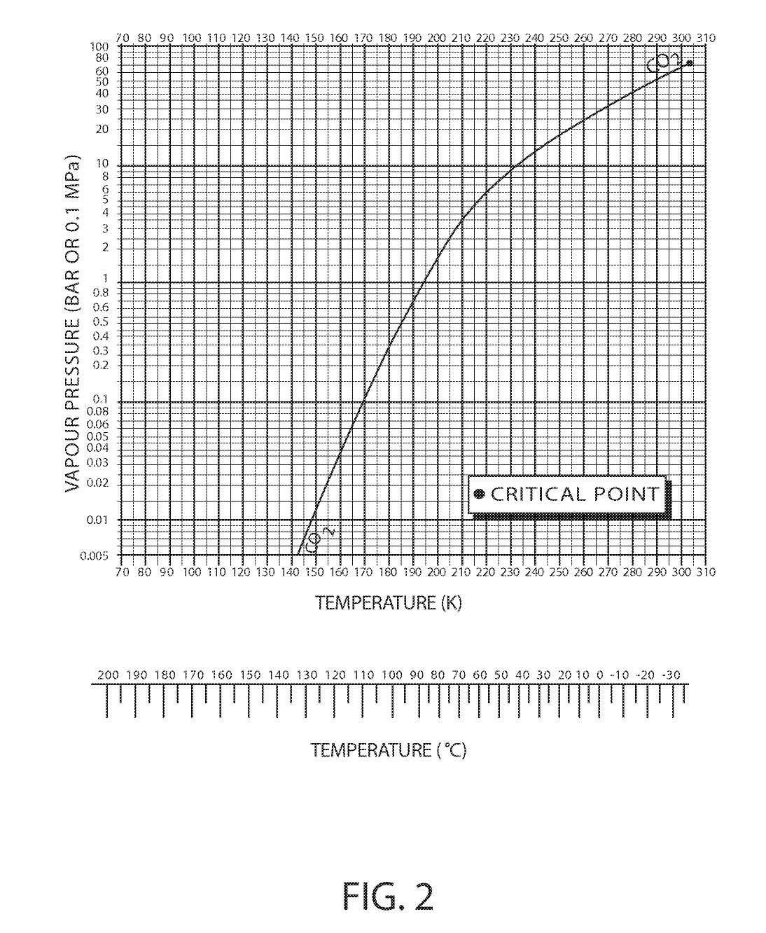

Coolant flow and/or temperature may be controlled by the RCB unit to regulate the system delivery pressure of the liquid CO2 from gas supply vessel 20 in accordance with the vapor pressure curve of CO2 as shown in FIG. 2. For example, an upper pressure limit of embodiments of the present system is 50 bar which corresponds to a CO2 temperature of about 14 degrees C., and lower limit of 10 bar corresponds to a temperature of about −40 degrees C. By regulating the coolant flow and/or temperature, the desired liquid CO2 pressure and flowrate may therefore be achieved without the need for high pressure liquid CO2 pumps as used in SFC chromatography systems. Operation of RCB 200 may be automatically controlled by controller 92 (further described herein) to achieve the desired temperature and pressure control of the CO2 in the chromatography system 10.

Gas supply vessel 20 is fluidly connected to a three-way valve 30 by a flow conduit 210 as shown in FIG. 1. Flow conduit 210 may be any suitable pressure containment flow conduit such as tubing and/or piping of an appropriate size and material to handle the temperature, pressure and particular material or fluid being conveyed therein through the conduit. All equipment of chromatography system 10 further described herein and shown in FIG. 1 similarly should be construed to be fluidly connected by a suitable flow conduit 210 where shown in this schematic flow diagram by the connecting lines and arrows indicating a principal flow direction (but not necessarily an exclusive flow direction). Every flow conduit 210 shown is not labeled in FIG. 1 to reduce clutter, but should be so assumed.

Referring to FIG. 1, CO2 flow normally is routed from valve 30 through a heat exchanger 40 to further cool and ensure that the CO2 remains in liquid state when mixed with a solvent further downstream in the process. In some embodiments, heat exchanger 40 includes cooling coils (not shown) fluidly connected to RCB 200 via cooling supply and return lines 202, 204. In an alternative operating scenario, the flow of CO2 may be routed via three-way valve 30 bypass the heat exchanger in situations such as when additional cooling of the CO2 is not needed.

The liquid CO2 then flows to a flow mixer 60 where it is combined with a solvent from the solvent supply system. Mixer 60 is configured to provide satisfactory mixing of the separate inlet CO2 and solvent streams to create a combined mobile phase upstream of column 80. Any commercially available flow mixer suitable for the application may be used, including a mixing tee. In some embodiments, a check valve 50 may be disposed in the flow conduit 210 between heat exchanger 40 and mixer 60 to eliminate potential backflow of CO2 in the system.

The solvent supply system includes a solvent pump 160 that pumps the solvent from a solvent container 150 to mixer 60. In various embodiments, the solvent feed system may operate in an isocratic or gradient mode. In the isocratic operating mode, a constant flow of solvent is fed to mixer 60 by pump 160 over the entire course of the elution. This type solvent feed system is suitable where a single strength mobile phase mixture (i.e. liquid CO2 and co-solvent) produces the desired separation of the compound of interest in the column 80.

Any suitable solvents may be used for the chromatographic separation including polar and non-polar organic solvents. The solvent selected will depend on the nature of the analyte to be separated in column 80. Solvent concentrations used in the mobile phase may range from between about 1 volume percent to 50 volume percent in various embodiments.

Where the sample is complex and contains compounds that differ greatly in column retention times, a gradient feed solvent system may be used in which the concentration of solvent in the mobile phase liquid CO2 changes and increases over the course of the elution. The gradient solvent feed may be a linear gradient type feed or elution profile (i.e. constantly increasing concentration of solvent over the elution time having a smoothly sloped increasing profile) or step gradient type (i.e. increase of solvent concentration over the elution time having a stepped increasing profile). Both type gradient system are well known to those skilled in the art.

Solvent pump 160 in some embodiments therefore is a gradient type pump configured and operable to pump solvent in either linear and/or step gradient operating modes. In some embodiments, pump 160 is configured and operable to pump solvent in both isocratic and gradient operating modes. Any suitable commercially-available chromatography solvent pump operable to deliver solvent at the desired pressure and manner (i.e. isocratic and/or gradient) to mixer 60 may be used. In one embodiments, pump 160 may be a HPLC pump with stepper motor control to produce gradient solvent flow. Pumps of the plunger or piston type are useable in this application for solvent pumps. The pump may be programmable for automatic operation or manually adjustable to achieve the desired gradient flow over time.

In some embodiments, a step profile gradient pump 160 having any suitable number of steps may be used. In one embodiment, a ten step-wise gradient solvent pump 160 is be used that incrementally increases the solvent flow to mixer 60 in stepped fashion while maintaining the overall mass flow of the combined solvent-liquid CO2 mobile phase flow to column 80. The liquid CO2 flow to mixer 60, whose pressure is not boosted by a CO2 pump in one preferred embodiment and remains relatively constant in contrast to the solvent delivery pressure, is incrementally reduced in flow being displaced by the stepped increase in solvent flow to the mixer from the solvent pump 160. Accordingly, the solvent pump 160 thus indirectly controls the mass flow of the liquid CO2 to mixer 60 and the overall combined mobile phase flow. In the event that the CO2 pressure begins to drop in gas supply vessel 20 as the compressed CO2 supply is diminished during use, in some embodiments the temperature of the CO2 may be increased by reducing coolant flow and/or operation of the coolant system to maintain pressure preferably up to 49 bar.

Solvent pump 160 has an operating pressure range with desired solvent flow capable of delivering solvent to the mixer 60 at pressures higher than the pressure of liquid CO2 being introduced into the mixer to allow for injection and mixing of the solvent in the combined mobile phase stream. Since in preferred embodiments, the CO2 or mobile phase pressure is preferably between 10-50 bar, a pump 160 having an outlet pressure in a range of at least greater than 50 bar may be used.

Valve 170 is disposed between pump 160 and mixer 60 to provide isolation from the mixer and allow the pressure of the solvent to be regulated for injection into the mixer 60. In some embodiments, valve 170 may be a three-way valve configured for injection 180 of the sample containing the compound(s) of interest to be separated by chromatography directly into the solvent stream for feeding into the separation column 80 with the liquid CO2. In other embodiments, the sample may instead be placed directly into column 80 or head of the column particularly when the sample is very viscous in nature allowing it to be coated on the inside of the column. Suitable three-way valves include without limitation Model LCC-31V-SS with Luer injection port available from LCC Engineering & Trading GmbH of Switzerland.

The solvent may be any suitable polar or non-polar solvent usable in chromatography separation that is capable of solubilizing another substance depending on whether the chromatography process is normal phase or reverse phase. In some embodiments, for example, typical solvents used may include without limitation MeOH, ethanol, acetone, and hexane.

With continuing reference to FIG. 1, the mobile phase mixture of liquid CO2 and co-solvent (also including the sample to be eluted in embodiments when pre-mixed with the solvent as described above) next flows directly from mixer 60 into a chromatographic separation column 80 preferably without any intervening temperature or pressure modification components (excluding possibly a column inlet isolation valve—not shown). The liquid CO2 with a very low viscosity and density carries the solvent into the column 80. In some cases, the sample to undergo chromatographic separation may have already been first placed directly in column 80 if not alternatively previously injected into the solvent stream as described above. Either injection or delivery point for the sample to be separated is satisfactory depending on the circumstances and nature of the material to be sampled and compounds of interest extracted.

Chromatography column 80 contains the pre-loaded stationary phase. Any suitable stationary phase material and sized particles may be used depending on the chemistry of the chromatography separation to be performed. In some embodiments, the stationary phase may be a silica-based adsorbent or another suitable adsorption material such as alumina and others. In some embodiments, silica or silica gel are used. The invention is therefore not limited to use of any particular stationary phase material.

In one embodiment, the adsorption material has an overall particle size of about and including 5 to 100 microns. The particles may have any shape including without limitation irregular, angular, spherical, spheroid, and others. In some preferred embodiments, the overall particle size is between and including 10 to 50 microns depending on the shape of the particle since, for example, spherical particles will exhibit less pressure drop across a packed column relative to irregular (or angular) shaped particles. Preferably, in some embodiments, the particle size is at least about 10 microns to reduce pressure drop through the column if smaller particle sizes are used.

FIGS. 4-7 shows exemplary, but non-limiting embodiments of column 80 useable in the present chromatography system 10. Column 80 is generally a cylindrically-shaped pressure vessel having an elongated cylindrical columnar body 305 structured and configured to withstand operating pressures contemplated between the column inlet 300 and outlet 301. To gain access to the interior cavity of column 80 defined by the body 305 for inserting and packing the stationary phase adsorbent material or inserting flash cartrdiges, removable and sealable top and/or bottom end caps may be provided. Column 80 therefore further includes top end cap 303 defining an inlet 300 and bottom cap 304 defining outlet 301. Inlet 300 and outlet 301 are openings formed through the end caps 303, 304 suitably sized to pass the liquid mobile phase flow anticipated through the column. End caps 303, 304 may be coupled to body 305 by any suitable means, including without limitation threaded connections in some embodiments as shown.

Cylindrical columnar body 305 of column 80 is made of a suitable material and thickness able to withstand the chemical conditions and operating pressures contemplated between the column inlet and outlet. In one embodiment, column 80 is configured for operating pressures of at least 50 bars (plus a suitable engineering design factor of safety) representing the maximum preferred operating pressure the liquid CO2 mobile phase at the head of the column 80. According, column 80 in one embodiment is designed for an internal operating pressure of about 1000 psi (69 bar).

Column 80 is made from stainless steel in one embodiment, such as 316 stainless in some embodiments. Other materials can be substituted including other metals or non-metal materials such as without limitation plastic provided they can withstand 1000 psi and tolerate the physical and chemical conditions of the process.

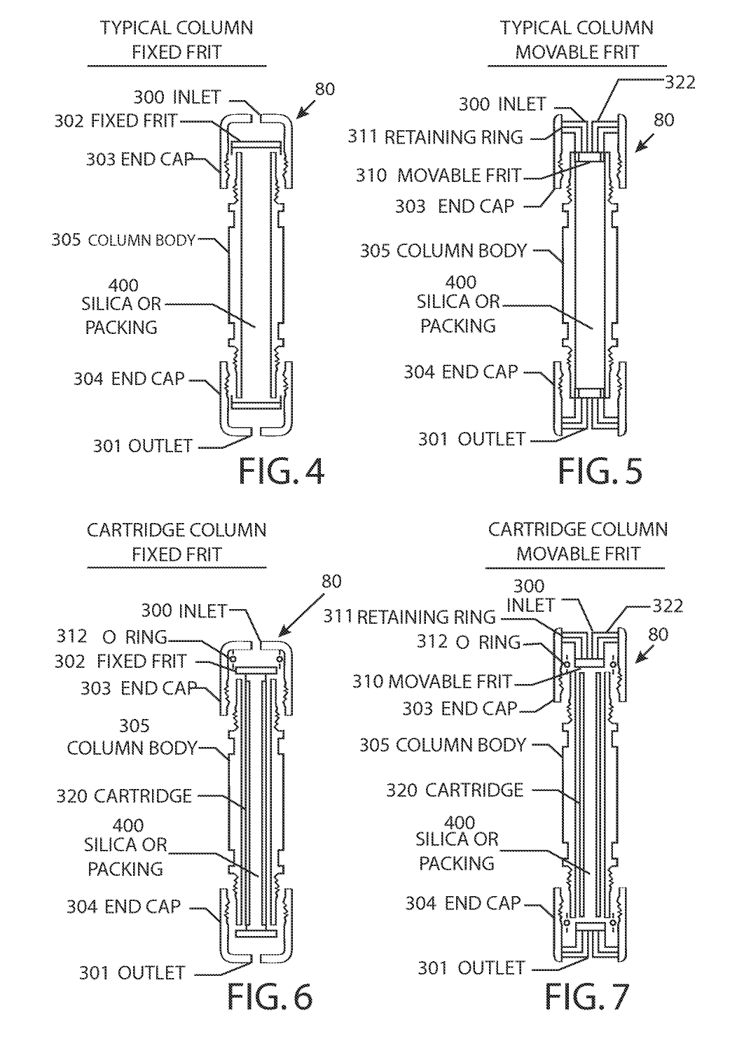

Column 80 shown in the embodiments of FIGS. 4 and 5 are intended to be directly packed with adsorbent stationary phase material 400. Solid adsorbent material particles may be dry packed such as via piston packed directly into the column by any suitable means used in the art in some embodiments. A sample loading chamber may be provided in the column 80 in a conventional manner for use when the sample material to be separated is placed into the column in lieu of injection with the mobile phase upstream thereof as described herein. Liquid stationary phase adsorbent material in embodiments when used may be coated directly on the interior walls of the columnar body 305. Accordingly, stationary phase material may fill virtually the entire inside volume of the column (solid packed column) or be concentrated along the interior walls leaving an relatively open central passageway through the column 80 for flow of the compressible liquid mobile phase.

With continuing reference to FIGS. 4-7, column 80 may further include one or more fixed frits 302 or movable frit 310 to retain the adsorbent material 400 particles, and also to perform a variety of filtration functions. End caps 303, 304 may help position and retain the frits in some embodiments. The movable frits 310 are axially slidably movable within the column body 305 (FIG. 5) or flash cartridge 320 (see FIG. 7), and supported by a frit support assembly 322 engageable and axially movable with end caps 303 and 304.

Alternatively, in other embodiments as shown in FIGS. 6 and 7, column 80 may be configured to removably receive separate insertable and disposable chromatography flash cartridges 320 pre-packed with the desired adsorption material 400. Such flash cartridges are generally cylindrical in shape and well known in the art. Flash cartridges are commercially-available from companies such as Applied Separations, Inc. of Allentown, Pa. In some exemplary embodiments, the flash cartridges may have a cavity therein for holding the adsorbent with cavity sizes that range from about and including 10 cm to about and including 20 cm. A sample loading chamber may be provided in some embodiments. Since the cartridges are supported against the column pressures by the shell of the column, they may be constructed of relatively lighter-weight disposable materials different than the column 80 which serves as the primary pressure retention vessel.

Embodiments of columns 80 shown in FIGS. 6 and 7 configured for flash cartridges 320 may include a further sealing mechanism to seal the column-flash cartridge assembly such as retaining rings 311, which in some embodiments may be O-rings.

In one embodiment, disposable flash cartridges removably useable in column 80 are made out of plastic in one embodiment such as polypropylene but could also be made out of any other plastic materials or metal that are configured to fit inside of column 80.

Chromatography column 80 may be of any suitable diameter, length, material, and configuration may be used depending on the type of material separation to be performed and whether the column is configured for direct packing or to accept removable flash cartridges. Columns 80 of either the direct packing or insertable flash cartridge designs are commercially available and well known to those skilled in the art without further elaboration.

Due to the pressure drop resulting across the chromatography separation column 80, the column is also preferably cooled in some embodiments to maintain an operating pressure therein less than 50 bar to ensure that the CO2 stays liquid and in its mobile phase with the solvent when passing completely through the column. In some embodiments, the column 80 may be cooled by an outer coolant jacket fluidly connected to RCB 200 by cooling supply and return lines 202, 204 as shown in FIG. 1. Alternatively, cooling coils may also be used. The operating pressure within column 80 that is maintained at less than 50 bar by cooling the column advantageously enhances the Gyro-forming of the sample on the column and improves the chromatographic separation. Pressure drops across the column 80 from inlet to outlet may be between about 1-50 bar, more preferably about 1-20 bar, and even most preferably between about 5-10 bar.

Column 80 temperatures are held in some embodiments between about −40 degrees C. and 30 degrees C., and preferably between about −30 degrees C. to 14 degrees C. in other embodiments.

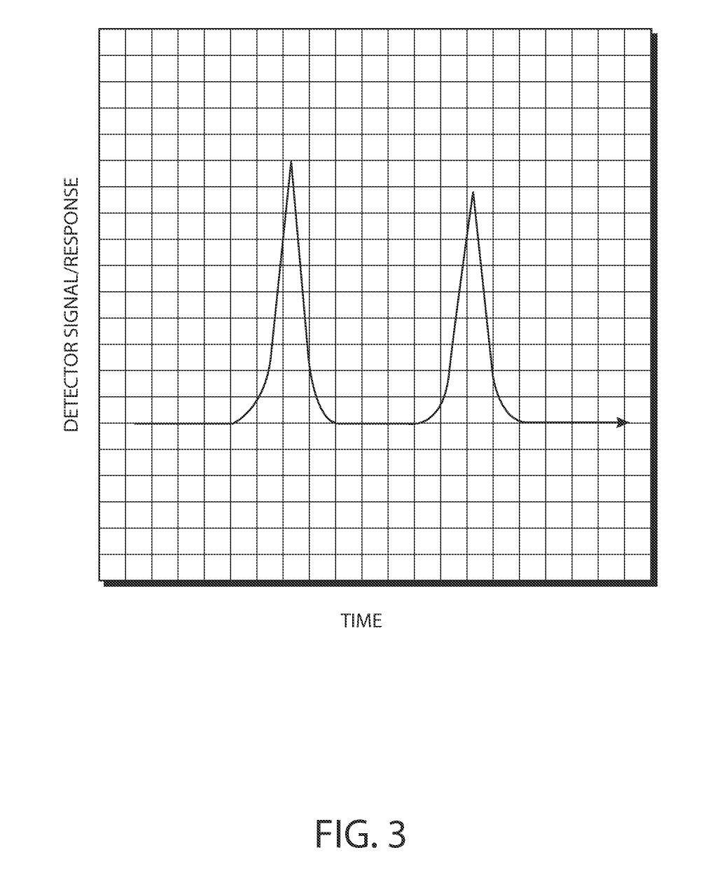

With continuing reference to FIG. 1, the chromatography process continues with the analyte or eluate from chromatography separation column 80 (i.e. mobile phase including the separated compound(s) of interest) then passes through a detector 90 operable to detect concentrations of the compounds of interest in the sample which are entrained in the mobile phase CO2 carrier. Detector 90 is a liquid chromatography type detector operable to identify the presence of the analyte compound of interest in the liquid CO2 mobile phase. Any suitable detector used in the art for chromatographic separation may used, such as without limitation ultraviolet, infrared, mass spectroscopy, refractive index, light scattering, or other types of detectors which are well known to those skilled in the art. Detector 90 monitors and identifies when peaks are detected in the eluate over time indicating the presence of the compounds of interest, to in turn trigger downstream collection of fraction samples of those compounds. FIG. 3 shows a representative detector chromatogram including a baseline and peaks.

The flow of eluate continues from the detector 90 to a fraction collection system. The separated analyte sample contained in the liquid CO2 mobile phase may be collected either manually or automatically through use of a suitably programmed processor. With continuing reference to FIG. 1, a heated flow restrictor 100 and switching valve 110 may be provided for fraction collection. Flow restrictor 100 is located downstream of column 80 to receive the eluate comprising liquid CO2 along with separated compounds of interest when present in the eluate flowstream.

In one embodiment, the flow restrictor 100 is a fixed size orifice that is operable to control the maximum volume of mobile phase flow at any given pressure in the chromatography system 10. Gradient flow is achieved by restricting the total volume of flow through the chromatography system at a given pressure for the CO2 liquid (that is, for example 48 or 49 bar in some embodiments). Then, the flow of the incompressible solvent is initiated at a certain selected flow rate using solvent pump 160 which can introduce the solvent into the CO2 flow stream at a higher pressure than the CO2 liquid. This results in preferential passage of the volume of incompressible solvent through the system (due to its higher pressure) and the corresponding decrease in the relative volume of compressible liquid CO2 at the given pressure of the overall system. The predetermined diameter of orifice used in restrictor 100 can be pre-selected to correspond to predetermined columns sizes of a known weight in grams that will be used in the separation process. The single solvent pump 160 and fixed flow restrictor 100 (i.e. orifice) operate mutually to control the combined mobile phase flow (i.e. liquid CO2 and solvent) through the system 10.

In other possible embodiments contemplated, a selectively variable flow restrictor 100 such as any suitable commercially available valve (which is in essence a user adjustable orifice of variable size) can alternatively be used to provide the required back pressure on the column 80 and flow restriction based on the column sizes and packing used in the process. Operation of a flow restrictor valve to change the size or diameter of the variable valve orifice and corresponding flow passing through the valve which produces the backpressure on the column can be changed either manually or preferentially through use of controller 92 as further described herein.

With continuing reference now to FIG. 1, switching valve station 110 is operable for controlling and directing the flow of eluate to waste or to one or more collection vessels when the eluate contains the compounds of interest. In one embodiment, valve station 110 comprises a plurality of valves 112 fluidly coupled to flow conduit 210 from flow restrictor 100 and arranged to route the mobile phase liquid CO2 flow to multiple destinations. In various embodiments, the switching of the valve positions (i.e. opening certain valves and closing other valves to change flow paths through valve station 110) is controlled either manually or automatically via electrical output control signals generated by a processor such as programmable controller 92 associated with detector 90, or alternatively a main programmable PLC such as a computer configured to control the operations of the entire chromatography separation system 10 or particular portions of the system and process. The processor or PLC may be on-board with detector 90 or in a standalone computer associated with the detector or alternatively the entire system 10 in general. Such processors and programming are well known to those skilled in the art.

A conventional PLC or computer system, which may comprise for example a server, computer, or any device or group of devices that may be configured to transmit, receive, and/or store data, are suitable for use in connection with embodiments of the present invention. A PLC or computer may include one or more processors, which may be connected to a wired or wireless communication infrastructure (e.g., a communications bus, cross-over bar, local area network (LAN), or wide area network (WAN)). Processor(s) may be any central processing unit, microprocessor, micro-controller, computational device, or like device that has been programmed to form a special purpose processor for performing the computer functions. In some embodiments, processor(s) may be configured to run a multi-function operating system.

Memory provided with the PLC or computer system may be a local or working memory, such as, a random access memory (RAM) while secondary memory may be a more persistent memory. Examples of secondary memory include, but are not limited to, a hard disk drive(s) and/or removable storage drive(s) representing a floppy disk drive, a magnetic tape drive, an optical disk drive, or the like. A removable storage drive, if employed, may read from and/or write to a removable storage unit. Removable storage unit(s) may be a floppy disk, magnetic tape, CD-ROM, DVD-ROM, optical disk, ZIP™ drive, Blu-Ray disk, and the like, which may be written to and/or read by a removable storage drive. In some embodiments, secondary memory may include other similar devices for allowing computer programs or other instructions to be loaded into a computer, such as, a removable storage device and an interface. An example of such a removable storage device and interface includes, but is not limited to, a USB flash drive and associated USB port, respectively. Other removable storage devices and interfaces that allow software and data to be transferred from the removable storage device to a computer may be used.

A conventional PLC or computer system may further include a communications interface that allows software and data to be transferred between a computer and external devices. Examples of communications interface may include a modem, a network interface (such as an Ethernet or wireless network card), a communications port, a Personal Computer Memory Card International Association (PCMCIA) slot and card, or the like. Software and data transferred via a communications interface are in the form of signals which may be electronic, electromagnetic, optical, or any other signal capable of being received by the communications interface. These signals are provided to the communications interface via a communications path or channel. The path or channel that carries the signals may be implemented using wire or cable, fiber optics, a telephone line, a cellular link, a radio frequency (RF) link, or the like.

It will be understood that operation and control aspects of the present invention may therefore be embodied in the form of computer-implemented processes and apparatus for practicing those processes. Aspects of the present invention with respect to software comprised of processor/computer program instructions or control logic configured to control operation of chromatography system 10 and the components/processes described herein may be embodied in tangible computer readable non-transitory storage media encoded with computer program code or instructions, such as random access memory (RAM), floppy diskettes, read only memories (ROMs), CD-ROMs, ZIP™ drives, Blu-Ray disks, hard disk drives, flash memories, or any other machine-readable storage medium, such that when the computer program code is loaded into and executed by a computer, the computer becomes a particular machine for practicing the invention. When implemented on a general-purpose processor, the computer program code segments configure the processor to create specific logic circuits. The invention may alternatively be embodied in a digital signal processor formed of application specific integrated circuits (ASICs) for performing a method according to the principles of the invention.

Controller 92 should therefore be broadly construed to include any of the foregoing electronic devices and processor system related components that automatically control one or more functional aspects of the chromatography system described herein.

With continuing reference now to FIG. 1, valve switching station when controlled by controller 92 for automatic operation functions such that when an output signal is received by valve switching station 110 from controller 92 indicating detector 90 has measured the start of a chromatographic peak (thereby corresponding to the presence of the compounds of interest in the CO2 eluate stream—see, e.g. FIG. 3), switching of valves 112 is triggered to direct the eluate flow to a heated separator 130 for recovery of an analyte sample of the compound. When the detector eluent measurement profile returns to a flat baseline value (indicating primarily the presence of liquid CO2 carrier alone), the position of valves 112 is triggered by a control signal output from controller 92 to dump the eluate to a waste container 120 until the next peak is detected. Valves 112 accordingly may include suitable electric valve operators as are known to those skilled in the art which operate to receive the output control signals from controller 92 and change the valve between open to closed positions to pass or block the flow of eluent.

The foregoing controllers or processors are well known in the art. It is within the ambit of those skilled in the art to therefore provide a suitable processor programmed to provide the required functionality. In alternative embodiments of the chromatography system, the valve 112 switching may be performed manually and controlled based on time and/or visually monitoring the detector 90 readings and/or display for the presence of peaks and desired compounds to be separated and collected. In some possible embodiments, operation of switching valve station 110 could also be controlled solely based on time without a detector 90.

In other possible embodiments, switching valve station 110 may be a single switching valve commonly used in chromatography separation systems for fraction collection. As will be well known to those skilled in the art, a suitable switching valve in some embodiments will include a central inlet port and channel fluidly communicating with at least two user-selectable target or destination outlet ports to direct the eluent to waste collector 120 or heated separator 130 for analyte sample collection. Switching valves are commercially-available.

With continuing reference to FIG. 1, heated separator 130 heats the eluate from valve station 110 to evaporate and speed the conversion of the liquid CO2 mobile phase to a gaseous state. The CO2 gas is then removed from the separator. The remaining analyte compound sample of interest is collected in a sample collector vessel 140. An isolation valve 132 may be disposed between the separator 130 and vessel 140 in some embodiments.

It is notable that the compressible liquid CO2 chromatography separation process disclosed herein advantageously provide almost the same results of SFC or high pressure flash chromatography while using less solvent and achieving good separations through the column, but advantageously without the high cost of SFC or high pressure flash chromatography.

Another advantage of the compressible liquid CO2 chromatography separation process disclosed herein is quicker separation of the analyte sample from the mobile phase than low pressure liquid chromatography (LPLC) using incompressible solvents which is respectively slower and longer. Using compressible solvents according to the present disclosure, the time required to separate the solvent from the sample is greatly reduced, generally proportional to the amount of compressible fluid used to make up the mobile phase. The reason for this is that under standard conditions (temperature and pressure), the compressible solvent quickly reverts to a gas, thereby speeding the sample recovery process.

Further advantages are possible using the compressible liquid CO2 chromatography separation process disclosed herein. MPLC (medium pressure liquid chromatography), LPLC described above, HPLC (high performance liquid chromatography) using high pressure, and UHPLC (Ultra High Pressure Liquid Chromatography) are all performed using incompressible liquid solvents. Supercritical fluid chromatography (SFC) is a high pressure process using compressible fluids such as CO2 as already described herein. The surface tension of supercritical CO2 is zero by definition. By contrast, the surface tension of the solvents used in incompressible liquid chromatography (MPLC, LPLC, HPLC, UHPLC) typically can range from 20 to 120 dynes/cm. SFC results in results in faster separation times in contrast to the foregoing incompressible liquid chromatography due to the higher surface tensions of their incompressible fluids.

Advantageously, the surface tension of liquid CO2 used in embodiments of the chromatography system and process according to the present disclosure is approximately 1.5 dynes per cm which is nearer that of SFS, and significantly lower than incompressible liquid chromatography (MPLC, LPLC, HPLC, UHPLC) described above. Compressible CO2 liquid chromatography according to embodiments of the present invention which operate at pressures less than 50 bar therefore offers most of the benefits of SFC (i.e. very low surface tension with corresponding faster sample recovery speeds), but at a significantly reduced cost of system ownership than SFC due to the low pressure component design, more similar to incompressible liquid chromatography.

It should further be noted that MPLC is typically performed using incompressible liquids at room temperature or above, and differs from the present compressible CO2 liquid chromatography system in that at a given pressure, e.g., 20 bar, chilling of the compressible liquid would be required to maintain liquidity of the compressible liquid and this change in temperature can affect the separation thermodynamics of the chromatography system.

The compressible liquid CO2 chromatography separation process disclosed herein can be readily employed in the laboratory setting and is scalable for industrial separation applications. In addition, although the compressible liquid CO2 chromatography separation process disclosed herein is described with respect to using CO2 as the mobile phase, the present process can use other suitable compressible fluids adapted for chromatographic separations.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

What is claimed is:

1. A method for separating a sample using liquid flash chromatography, the method comprising:
providing a pressure vessel containing a stationary phase adsorption material;
providing a compressible fluid defining part of a liquid mobile phase for delivery to the pressure vessel;
maintaining the compressible fluid in a liquid state before delivery to the pressure vessel;
mixing a co-solvent with the compressible fluid thereby defining a liquid mobile phase;
eluting the liquid mobile phase and the sample through the pressure vessel to extract a separated sample, wherein the pressure vessel is maintained between 10 and 50 bar during the elution;
heating the mobile phase containing the separated sample to separate the mobile phase from the separated sample; and
collecting the separated sample.

2. The method of claim 1, further comprising cooling the pressure vessel to maintain the pressure between 10 and 50 bar.

3. The method of claim 1, further comprising depressurizing the compressible fluid to maintain the compressible fluid in a liquid state before delivery to the pressure vessel.

4. The method of claim 3, wherein the compressible fluid is cooled to below 14 degrees C. to depressurize the fluid.

5. The method of claim 1, wherein the compressible fluid is maintained between 10 to 50 bars before eluting the liquid mobile phase and the sample through the pressure vessel.

6. The method of claim 1, wherein the compressible fluid is carbon dioxide.

7. The method of claim 1, wherein the compressible fluid is provided in a gas supply vessel, and further comprising cooling the gas supply vessel.

8. The method of claim 1, wherein the adsorption material has a particle size of about 5-100 microns.

9. The method of claim 1, wherein the adsorption material is dry packed into the pressure vessel.

10. The method of claim 1, wherein the adsorption material is disposed directly into the pressure vessel.

11. The method of claim 1, wherein the adsorption material is disposed in a removable cartridge inserted in the pressure vessel.

12. The method of claim 1, wherein the sample is loaded directly into the pressure vessel.

13. The method of claim 1, wherein the sample is injected in the mobile phase prior to elution through the pressure vessel.

14. The method of claim 20, wherein the mobile phase is recycled after collecting the separated sample.

15. The method of claim 1, wherein said adsorption material is a silica-based adsorbent.

16. A method for separating a sample using liquid carbon dioxide flash chromatography, the method comprising: providing a pressure vessel containing a stationary phase adsorption material;
providing liquid carbon dioxide for delivery to the pressure vessel;
depressurizing the liquid carbon dioxide to between 10 and 50 bar to maintain a liquid state through the pressure vessel;
introducing a non-compressible co-solvent into the liquid carbon dioxide to create a liquid mobile phase;
eluting the liquid mobile phase and the sample through the pressure vessel to extract a separated analyte sample;
heating the mobile phase containing the separated analyte sample to separate the mobile phase from the separated analyte sample; and
collecting the separated analyte sample.

17. The method of claim 16, further comprising cooling the pressure vessel to maintain the pressure of the liquid mobile phase therein between 10 and 50 bar.

18. A compressible liquid flash chromatography system comprising:
a pressure vessel containing a stationary phase adsorption material;
a gas supply vessel holding a compressed liquid;
a heat exchanger for controlling the temperature of the compressed liquid, the heat exchanger fluidly coupled to the gas supply vessel and operable to cool the compressed liquid;
a solvent supply system including a solvent pump for pumping an incompressible co-solvent;
a mixer configured for receiving the compressed liquid from the heat exchanger and co-solvent from the solvent pump, the mixer being operable to combine the compressed liquid and co-solvent to form a liquid mobile phase and to deliver the liquid mobile phase to the pressure vessel; and
a cooling system operably cooling the pressure vessel and gas supply vessel;
wherein the temperature of the compressed liquid and liquid mobile phase is maintained between 10 and 50 bar.

19. The system of claim 18, wherein the cooling system provides coolant to the heat exchanger.

20. The system of claim 18, further comprising a flow restrictor, the flow restrictor operable with the solvent pump to maintain a substantially constant combined mass flow of liquid mobile phase to the pressure vessel.
